(19) United States
(12) Patent Application Publication
(10) Pub. No.: US 2012/0006039 A1
(43) Pub. Date: Jan. 12, 2012

(54) Kimchi refrigerator and control method thereof

(75) Inventors: Kyung Tae Kim, Gwangju-si (KR); Ki Hyun Kim, Suwon-si (KR)

(73) Assignee: SAMSUNG ELECTRONICS CO., LTD., Suwon-si (KR)

(21) Appl. No.: 13/067,447

(22) Filed: Jun. 1, 2011

(30) Foreign Application Priority Data
Jul. 6, 2010 (KR) 10-2010-0064858

(51) Int. Cl. F25B 49/00; G08B 21/18

(52) U.S. Cl. 62/129; 340/585

(57) ABSTRACT

A kimchi refrigerator and a control method thereof, in which salinity of kimchi introduced into the kimchi refrigerator is displayed and a storage temperature corresponding to the salinity is displayed so as to widen a user's range of selection of kimchi flavors and improve kimchi storage performance of the kimchi refrigerator. The control method includes measuring salinity of kimchi, determining a storage temperature based on the measured salinity, and displaying the determined storage temperature through a display unit. Thereby, the control method enables a user to select an appropriate storage temperature based on the displayed salinity and recommended storage temperature of the kimchi, thereby improving kimchi storage performance of the kimchi refrigerator. Further, the control method allows a recommended ripening or storage time according to the salinity of the kimchi to be displayed, thereby improving kimchi storage performance of the kimchi refrigerator.

### CROSS-REFERENCE TO RELATED APPLICATIONS

This application claims the benefit of Korean Patent Application No. 2010-0064858, filed on Jul. 6, 2010 in the Korean Intellectual Property Office, the disclosure of which is incorporated herein by reference.

### BACKGROUND

1. Field

Embodiments relate to a kimchi refrigerator, which senses a state of kimchi and stores the kimchi based on the sensed state, and a control method thereof.

2. Description of the Related Art

Recently, kimchi refrigerators specifically adapted to kimchi storage have been developed and placed on the market. A kimchi refrigerator is operated so as to apply an appropriate temperature to kimchi introduced into storage chambers to ripen the kimchi and then to preserve the kimchi for a long time while maintaining an appropriate storage temperature.

A general chest-type kimchi refrigerator is configured such that doors installed on the upper surface thereof are vertically rotated to be opened and closed so as to allow a user to put or take kimchi into or out of storage chambers. Heaters to generate heat to maintain an appropriate temperature during ripening of the kimchi, and components of a refrigerating system to maintain a regular low temperature state of the kimchi during storage of the kimchi are installed in the kimchi refrigerator. When fresh kimchi is introduced into the kimchi refrigerator, a ripening process in which an appropriate temperature is supplied to the kimchi to ripen the kimchi is carried out. Such a ripening process is a process of maintaining an appropriate temperature to ripen the kimchi using heat generated from the heaters. When the ripening of the kimchi through the above process is completed, a process of storing the kimchi is carried out by operating the components of the refrigerating system. Such a storage process is a process of circulating a refrigerant using the refrigerating system to maintain a proper low temperature state so as to prevent kimchi from spoiling.

The rate at which kimchi fermentation proceeds varies according to temperature. That is, if a temperature is high, the rate at which kimchi fermentation proceeds is high and thus kimchi is rapidly ripened, and if a temperature is low, the rate at which kimchi fermentation proceeds is low. Particularly, a flavor of kimchi greatly depends on a ripening state of the kimchi. If kimchi is ripened at a high temperature, a ripening period of the kimchi is short but the flavor of the kimchi is worse than that of kimchi ripened at a low temperature, and if kimchi is ripened at a low temperature, the flavor of the kimchi is good but a ripening period of the kimchi is excessively long.

Further, the rate at which kimchi fermentation proceeds varies according to salinity of kimchi. That is, if kimchi has low salinity, the kimchi is ripened rapidly, and if kimchi has high salinity, the kimchi is ripened slowly. Therefore, ripening temperature and ripening period of kimchi need to be properly adjusted according to salinity of the kimchi.

The conventional kimchi refrigerator stores kimchi at fixed temperatures, i.e., high, middle, and low temperatures, selected by a user, and is unsatisfactory in storing the kimchi in consideration of storage temperature or storage time of the kimchi according to salinity of the kimchi.

### SUMMARY

Therefore, it is an aspect to provide a kimchi refrigerator and a control method thereof, in which salinity of kimchi is measured, and relevant data are provided to a user and a storage stage of the kimchi desired by the user is determined based on the measured salinity.

Additional aspects of the invention will be set forth in part in the description which follows and, in part, will be apparent from the description, or may be learned by practice of the invention.

In accordance with one aspect, a control method of a kimchi refrigerator includes measuring salinity of kimchi, determining a storage temperature based on the measured salinity, and displaying the determined storage temperature through a display unit.

The determined storage temperature may be displayed as a recommended storage temperature through the display unit. A user may be informed that the determined storage temperature is the recommended storage temperature through a display or an audio signal. Here, the displayed recommended storage temperature may be flickered.

If a user does not select the recommended storage temperature for a designated time, the kimchi may be stored at the recommended storage temperature.

The recommended storage temperature may be displayed as a recommended storage temperature zone.

The measured salinity may be displayed separately from the recommended storage temperature or be displayed together with the recommended storage temperature.

In accordance with another aspect, a control method of a kimchi refrigerator comprising measuring salinity of kimchi, determining a ripening or storage time based on the measured salinity, and displaying the determined ripening or storage time as a recommended ripening or storage time through a display unit.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a perspective view illustrating a configuration of a kimchi refrigerator in accordance with one embodiment;

FIG. 2 is a plan view illustrating a structure of a conventional kimchi storage container;

FIG. 3 is a plan view illustrating a structure of a kimchi storage container in accordance with one embodiment;

FIG. 4 is a block diagram of a kimchi refrigerator in accordance with one embodiment;

FIG. 5 is a flow chart illustrating an operating process of a kimchi refrigerator in accordance with one embodiment;

FIG. 6 is a flow chart illustrating an operating process of a kimchi refrigerator in accordance with a further embodiment; and

FIG. 7 is a flow chart illustrating an operating process of a kimchi refrigerator in accordance with another embodiment.

### DETAILED DESCRIPTION

Reference will now be made in detail to the embodiments, examples of which are illustrated in the accompanying drawings, wherein like reference numerals refer to like elements throughout.

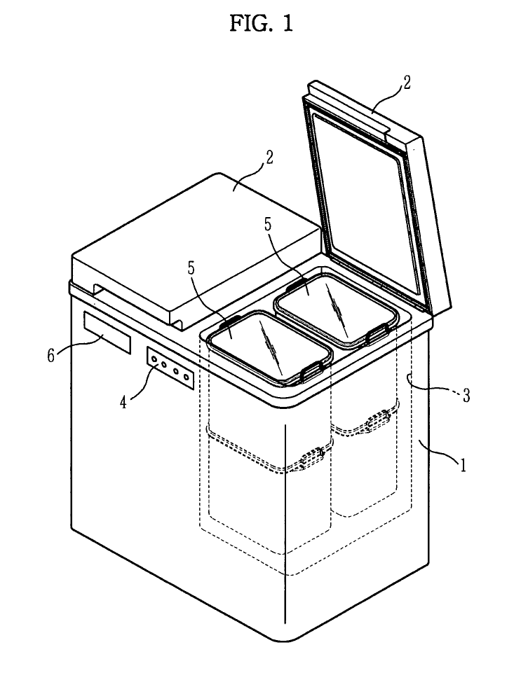

FIG. 1 is a perspective view illustrating a configuration of a kimchi refrigerator in accordance with one embodiment. The kimchi refrigerator includes a plurality of storage chambers 3 provided in a cabinet 1 forming a chest-type external appearance of the kimchi refrigerator so as to ripen kimchi and store the kimchi at a low temperature, a heater 400 to supply heat to ripen the kimchi, and a refrigerating system (including a compressor, a condenser and an evaporator) 500 to lower the temperature of the storage chambers 3 so as to store the kimchi at the low temperature.

The plurality of storage chambers 3 is prepared in a pair such that the storage chambers 1 are arranged in parallel at both sides of the cabinet 1 and are provided with opened upper surfaces. Doors 2 are hinged to the opened upper surfaces of the storage chambers 3 so as to be vertically rotated, thereby enabling the storage chambers 3 to receive kimchi. Further, a plurality of kimchi storage containers 5 is provided in each storage chamber 3.

The heater 400 is provided to supply heat of an appropriate temperature to kimchi introduced into the kimchi storage container 5 so as to ripen the kimchi. The heater 400 may be provided as a sheet manufactured by covering electric wires, integrally connected, with a rectangular sheath made of aluminum so as to supply heat to the kimchi storage container 5.

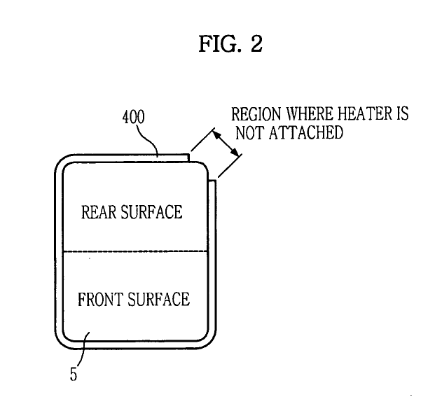

A heat transfer degree in the kimchi storage container 5 is varied according to an installation type of the heater 400 on the kimchi storage container 5. In case of a conventional kimchi refrigerator, as shown in FIG. 2, the heater 400 to heat the kimchi storage container 5 so as to raise the internal temperature of the kimchi storage container 5 is non-symmetrically installed on the front and rear surfaces of the kimchi storage container 5. Therefore, heat generated by the heater 400 is not uniformly transferred to the entirety of the kimchi storage container 5, and thus a storage temperature or a storage temperature distribution in the kimchi storage container 5 is varied.

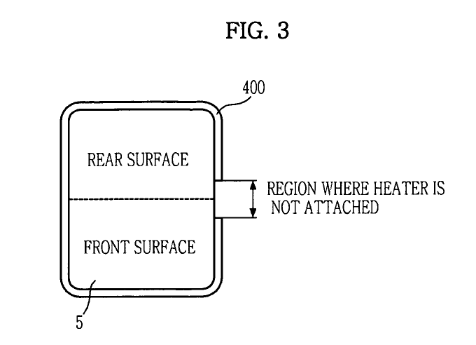

In order to achieve uniform heat transfer in the kimchi storage container 5, the kimchi storage container 5 and the heater 400 are configured as shown in FIG. 3. The kimchi storage container 5 is structurally divided into a front kimchi storage container part and a rear kimchi storage container part. The heater 400 is attached to the kimchi storage container 5 such that a section of the kimchi storage container 5 to which the heater 400 is attached is symmetrically disposed at the same positions of the front and rear surfaces of the kimchi storage container 5. That is, when the heater 400 is attached to the kimchi storage container 5, a starting point of the heater 400 and an ending point of the heater 400 may be located at positions of the front and rear surfaces of the kimchi storage container 5, separated from the boundary between the front and rear surfaces of the kimchi storage container 5 by the same distance. Therethrough, an amount of heat generated by the heater 400 is uniformly transferred to the entirety of the kimchi storage container 5, thereby uniformly ripening and storing kimchi in the kimchi storage container 5.

An operation unit 4 and a display unit 6 are provided on the front surface of the cabinet 1. The display unit 6 displays a storage temperature and a storage time, and the operation unit 4 receives user input to operate the kimchi refrigerator. The operation unit 4 and the display unit 6 may be integrated into a touch screen, or be provided separately. The display unit 6 may include a plurality of liquid crystal displays (LCD), light-emitting diodes (LED), or plasma display panels (PDP), but is not limited thereto. The operation unit 4 may include switches, buttons, slide bars, and dials, but is not limited thereto.

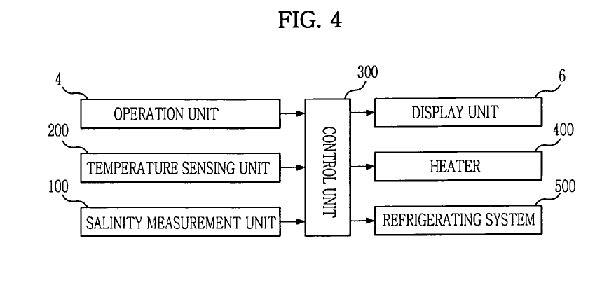

FIG. 4 is a block diagram of a kimchi refrigerator in accordance with one embodiment.

A control unit 300 receives signals from the operation unit 4, a temperature sensing unit 200, and a salinity measurement unit 100, and controls the display unit 6, the heater 400, and the refrigerating system 500 based on the signals.

The temperature measurement unit 200 is installed on the storage chamber 3 or the kimchi storage container 5, and measures a temperature of the storage chamber 3 or the kimchi storage container 5. Further, the temperature measurement unit 200 transmits the measured temperature as an electrical signal to the control unit 300.

The salinity measurement unit 100 measures salinity of kimchi. More specifically, the salinity measurement unit 100 measures salinity of kimchi through contact with the kimchi or a kimchi liquid. Measurement of the salinity of the kimchi using the salinity measurement unit 100 is carried out through one of methods described below.

First, there is a refractive index measurement method in which salinity of a light-transmitting target article is calculated using a principle that, when light generated from a laser module is irradiated onto the light-transmitting target article, the light is refracted by the article and a refractive index of the target article varies according to the salinity of the target article. Second, there is a chloride ion (Cl−) concentration measurement method in which salinity of a target article is calculated by injecting a reagent containing silver ions (Ag+) into the target article and then calculating a concentration of chloride ions (Cl−) through an amount of precipitated silver chloride (AgCl). Third, there is an electrical conductivity measurement method in which salinity of a target article is calculated by applying voltage to a pair of electrodes contacting the target article and then measuring current. This method uses a principle in which electrical conductivity of the target article is varied according to an ion concentration of the target article. Here, the applied voltage may be generated by a DC power supply or a (high-frequency) AC power supply.

The refractive index measurement method is disadvantageous in that the refractive index of the target article is affected by temperature as well as salinity, and the chloride ion (Cl−) concentration measurement method is disadvantageous in that the injected regent may be toxic. Therefore, the salinity measurement unit 100 may measure salinity of kimchi using the electrical conductivity measurement method.

The heater 400 is attached to the kimchi storage container 5, and raises the temperature in the kimchi storage container 5 to ripen kimchi in the kimchi storage container 5. The refrigerating system 500 includes a condenser, a compressor, and an evaporator, and lowers the temperature in the kimchi storage container 5 to store the kimchi in the kimchi storage container 5 at a low temperature.

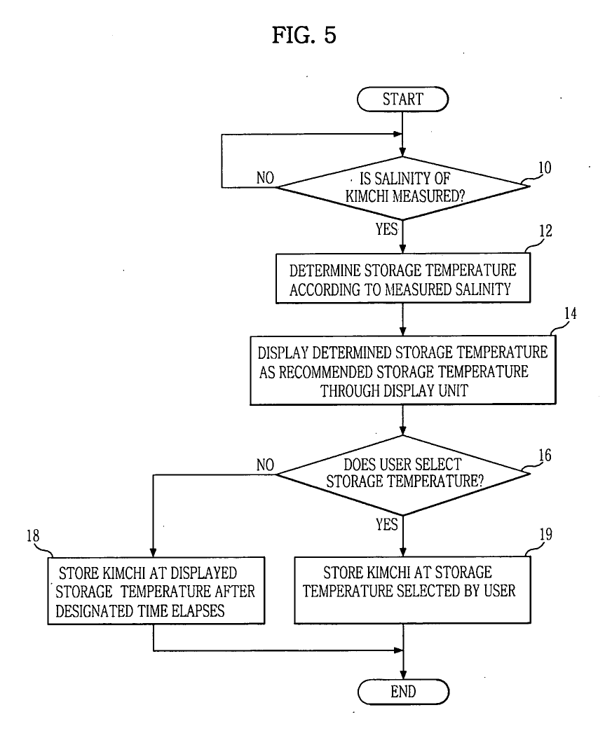

FIG. 5 is a flow chart illustrating an operating process of a kimchi refrigerator in accordance with one embodiment.

The operating process of the kimchi refrigerator in accordance with this embodiment will be described with reference to FIG. 5.

First, if the salinity measurement unit 100 fails to measure salinity of kimchi, for example, due to an error, the salinity measurement unit 100 repeats contact with the kimchi or a kimchi liquid and thus measures salinity of the kimchi, and if the salinity measurement unit 100 completes measurement of the salinity of the kimchi, the control unit 300 determines a storage temperature according to the measured salinity (operation 10). Even at the same storage temperature, a flavor of kimchi is varied according to salinity of the kimchi. Therefore, the control unit 300 determines an appropriate storage temperature to the salinity measured by the salinity measurement unit 100. For example, if the measured salinity is “1”, the appropriate storage temperature corresponding to the measured salinity is “A”, and if the measured salinity is “2”, the appropriate storage temperature corresponding to the measured salinity is “B”. As the measured salinity is increased sequentially to “1, 2, 3, . . . ”, the appropriate storage temperature corresponding to the measured salinity is increased in alphabetical order to “A, B, C, . . . ” at a designated rate. However, since a freezing point of kimchi is varied according to salinity of the kimchi, if the appropriate storage temperature of the kimchi according to the salinity of the kimchi is a temperature to freeze the kimchi, the control unit 300 informs a user of this (through the display unit 6 or a sound), or determines the appropriate storage temperature as a temperature not to freeze the kimchi (operation 12).

The control unit 300 displays the determined storage temperature through the display unit 6. The determined storage temperature is displayed to induce the user to make a selection. For this purpose, the display unit 6 notifies the user that the displayed storage temperature is a recommended storage temperature according to the salinity measured by the salinity measurement unit 100. The displayed recommended storage temperature serves to inform the user of the storage temperature corresponding to the current salinity of the kimchi. Further, the recommended storage temperature may be displayed as a designated storage temperature zone as well as a value or a slide bar. The designated storage temperature zone is a storage temperature range, in which the flavor of the kimchi may be maintained, corresponding to the measured salinity of the kimchi.

In order to display more efficiently, the recommended storage temperature to induce the user to make a selection, the displayed recommended storage temperature may be flickered through a switch of the display unit 6 or the operation unit 4. Numerals displayed on a screen of the display unit 6 may be flickered, or LED lamps installed on the operation unit 4 may be flickered. Further, the user may be informed that the temperature displayed on the display unit 6 or the operation unit 4 is the recommended storage temperature through an audio signal, such as a warning sound or music. That is, the user may be informed that the displayed storage temperature is the recommended storage temperature through a random method through which the user recognizes the recommended storage temperatures (operation 14).

The control unit 300 adjusts the temperature of the storage chamber 3 or the kimchi storage container 5 based on the temperature of the storage chamber 3 or the kimchi storage container 5 sensed by the temperature sensing unit 200. The control unit 300 determines whether or not the user selects a storage temperature through the operation unit 4 (operation 16), and upon determining that the storage temperature selected by the user is not the recommended storage temperature, the control unit 300 stores the kimchi at the selected storage temperature. In this case, the user desires kimchi which is incompletely or excessively ripened. Further, if the user does not selects the storage temperature for a designated time, the control unit 300 stores the kimchi at the recommended storage temperature, displays that the user does not selects the storage temperature, or informs the user that the user does not selects the storage temperature through a sound signal (operation 18). Upon determining that the storage temperature selected by the user is the recommended storage temperature, the control unit 300 stores the kimchi at the selected storage temperature (operation 19).

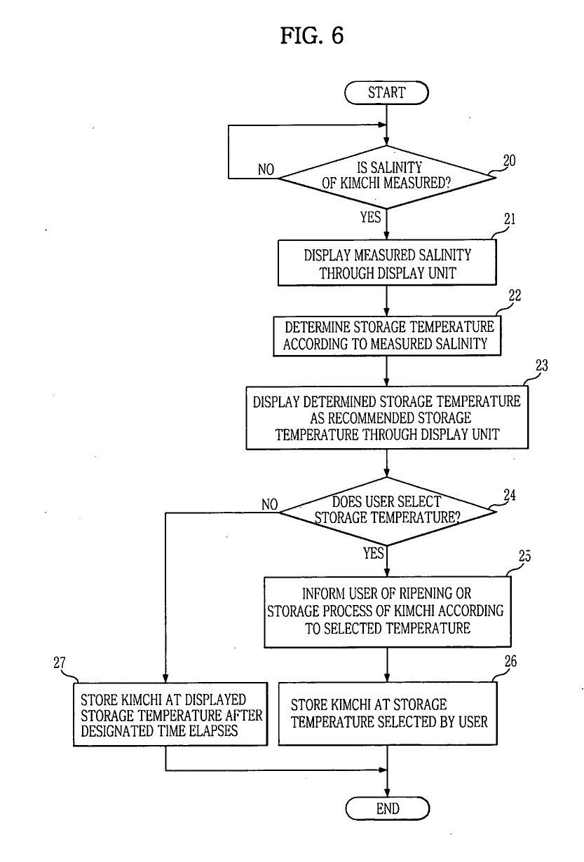

FIG. 6 is a flow chart illustrating an operating process of a kimchi refrigerator in accordance with a further embodiment.

FIG. 5 illustrates the operating process of the kimchi refrigerator in which an appropriate storage temperature according to salinity of kimchi measured by the salinity measurement unit 100 is displayed and the kimchi is stored at the appropriate storage temperature upon determining that a user selects the appropriate storage temperature. On the other hand, differing from the operating process of the kimchi refrigerator, as shown FIG. 5, FIG. 6 illustrates the operating process of the kimchi refrigerator in which salinity of kimchi measured by the salinity measurement unit 100 as well as the appropriate storage temperature is displayed on the display unit 6 and the kimchi is stored according to the measured salinity and the appropriate storage temperature.

First, the salinity measurement unit 100 measures salinity of kimchi through contact with the kimchi or a kimchi liquid (operation 20). Thereafter, the control unit 300 displays the salinity measured by the salinity measurement unit 100 through the display unit 6 such that a user may see the measured salinity. The displayed salinity may be expressed through a high, medium and low category display method or an actual value display method. The user may ripen or store the kimchi to achieve a desired flavor based on the displayed salinity. For example, when the salinity of the kimchi is high, if the user does not desire the kimchi having high salinity, additives to lower the salinity of the kimchi may be added to the kimchi, and if the user desires well-ripened kimchi, the storage temperature may be set to be high. Further, the measured salinity may be displayed together with a recommended storage temperature using the above-described method so as to allow the user to easily understand relations between the salinity and the storage temperature of the kimchi (operation 21).

The control unit 300 determines the appropriate recommended storage temperature according to the measured salinity (operation 22), and then displays the recommended storage temperature through the display unit 6 (operation 23). Thereafter, the control unit 300 determines whether or not the user selects a storage temperature through the operation unit 4 (operation 24), and displays a kimchi ripening or storing process corresponding to the recommended storage temperature through the display unit 6 or informs the user of the process by a sound, upon determining that the user selects the measured salinity or the recommended storage temperature according to the measured salinity (operation 25). For example, the control unit 300 may inform the user of a ripening or storage temperature of the kimchi having the measured salinity. If the user selects a temperature within a range except the recommended storage temperature, the control unit 300 displays the user of a process corresponding to the selected storage temperature through the display unit 6 or informs the user of the process by a sound. For example, the control unit 300 may inform the user that the kimchi may be rapidly ripened or incompletely ripened. If the user selects the salinity or recommended storage temperature displayed on the display unit 6, the control unit 300 stores the kimchi at the selected recommended storage temperature (operation 26). If the user does not select the displayed recommended storage temperature, the control unit 300 stores the kimchi at the displayed recommended storage temperature after a designated time elapses. Further, the control unit 300 displays that the user has failed to make a selection or generates a sound signal alerting the user that the user selection is failed, thereby inducing the user to make a selection (operation 27).

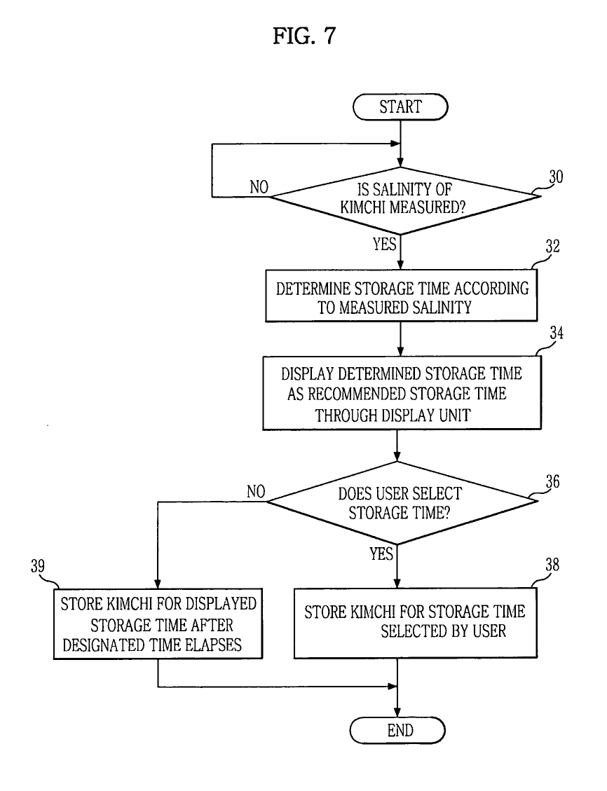

FIG. 7 is a flow chart illustrating an operating process of a kimchi refrigerator in accordance with another embodiment.

FIG. 5 illustrates the operating process of the kimchi refrigerator in which an appropriate storage temperature according to salinity of kimchi measured by the salinity measurement unit 100 is displayed and the kimchi is stored at the appropriate storage temperature upon determining that a user selects the appropriate storage temperature. On the other hand, differing from the operating process of the kimchi refrigerator as shown FIG. 5, FIG. 7 illustrates the operating process of the kimchi refrigerator in which a storage time of kimchi according to salinity of the kimchi is displayed and the kimchi is stored for the storage time upon determining that a user selects the storage time.

The salinity measurement unit 100 measures salinity of kimchi (operation 30), the control unit 300 determines a storage time according to the measured salinity (operation 32) and then displays the determined storage time as a recommended storage time through the display unit 6 (operation 34). The control unit 300 determines whether or not the user selects a storage time through the operation unit 4 (operation 36), and stores the kimchi for the selected storage time upon determining that the user select the storage time (operation 38). Upon determining that the user does not select the recommended storage time, the control unit 300 stores the kimchi for the recommended storage time after a designated time elapses (operation 39).

Further, in accordance with another embodiment, both the recommended storage temperature and the recommended storage time according to salinity of kimchi, as shown in FIGS. 5 to 7, may be considered.

Although the above-described embodiments illustrate measurement of salinity of kimchi and display of relevant data, the embodiments may be applied to food, salinity of which is measurable, such as soup and side dishes.

As is apparent from the above description, a kimchi refrigerator and a control method thereof in accordance with one embodiment enable a user to select an appropriate storage temperature based on displayed salinity and recommended storage temperature of kimchi, thereby improving kimchi storage performance of the kimchi refrigerator.

A kimchi refrigerator and a control method thereof in accordance with another embodiment enable a recommended ripening or storage time according to salinity of kimchi to be displayed, thereby improving kimchi storage performance of the kimchi refrigerator.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A control method of a kimchi refrigerator comprising:
measuring salinity of kimchi; and
displaying the measured salinity.

2. The control method according to claim 1, further comprising:
determining a storage temperature based on the measured salinity; and
displaying the determined storage temperature through a display unit.

3. The control method according to claim 2, wherein, in the displaying of the determined storage temperature through the display unit, the determined storage temperature is displayed as a recommended storage temperature through the display unit.

4. The control method according to claim 3, wherein, in the displaying of the determined storage temperature as the recommended storage temperature through the display unit, a user is informed that the determined storage temperature is the recommended storage temperature through a display or an audio signal.

5. The control method according to claim 3, wherein, in the informing that the determined storage temperature is the recommended storage temperature, the displayed storage temperature is flickered.

6. The control method according to claim 3, if a user selects the recommended storage temperature, further comprising displaying a ripening or storage process based on the recommended storage temperature through the display unit or informing the user of the ripening or storage process through an audio signal.

7. The control method according to claim 3, if a user does not selects the recommended storage temperature for a designated time, further comprising storing the kimchi at the recommended storage temperature.

8. The control method according to claim 3, if a user does not select the recommended storage temperature for a designated time, further comprising displaying that the user does not select the recommended storage temperature or informing the user that the user does not select the recommended storage temperature through an audio signal.

9. The control method according to claim 3, if a user does not select the recommended storage temperature and selects another temperature, further comprising displaying a ripening or storage process based on the selected temperature through the display unit or informing the user of the ripening or storage process through an audio signal.

10. The control method according to claim 3, wherein the recommended storage temperature is displayed as a recommended storage temperature zone.

11. The control method according to claim 1, further comprising:
determining a ripening or storage time based on the measured salinity; and
displaying the ripening or storage time through the display unit.

12. A kimchi refrigerator comprising:
a salinity measurement unit to measure salinity of kimchi; and
a display unit to display the measured salinity.

13. The kimchi refrigerator according to claim 12, further comprising a control unit to determine a storage temperature based on the measured salinity,
wherein the display unit displays the determined storage temperature.

14. The kimchi refrigerator according to claim 13, wherein the display unit displays the determined storage temperature as a recommended storage temperature.

15. The kimchi refrigerator according to claim 14, wherein the display unit displays the recommended storage temperature as a recommended storage temperature zone.

16. The kimchi refrigerator according to claim 14, wherein:
the control unit determines a ripening or storage time based on the measured salinity; and
the display unit displays the determined ripening or storage time as a recommended ripening or storage time.

17. The kimchi refrigerator according to claim 13, further comprising:
a kimchi storage container; and
a heater attached to the kimchi storage container such that a section of the kimchi storage container to which the heater is attached is symmetrically disposed at the same positions of front and rear surfaces of the kimchi storage container to achieve uniform heat transfer in the kimchi storage container.

18. The kimchi refrigerator according to claim 17, wherein a starting point of the heater and an ending point of the heater are located at positions of the front and rear surfaces of the kimchi storage container, separated from a boundary between the front and rear surfaces of the kimchi storage container by the same distance.
